(19) United States
(12) Patent Application Publication
(10) Pub. No.: US 2006/0278316 A1
(43) Pub. Date: Dec. 14, 2006

(54) Foldable tire structure

(76) Inventor: Vincent Cheng, Changhua City (TW)

Correspondence Address: CHARLES E. BAXLEY, ESQ., 90 JOHN STREET, THIRD FLOOR, NEW YORK, NY, 10038, US

(21) Appl. No.: 11/151,049

(22) Filed: Jun. 13, 2005

(51) Int. Cl. B60C 3/08; B60C 15/00

(52) U.S. Cl. 152/457; 152/540

(57) ABSTRACT

A foldable tire comprises a pair of beads interiorly inserted with a plurality of annular members; each of the annular members is made of a plurality of flexible steel filaments twisted together, and the diameter of the respective flexible steel filaments ranging from 0.5 mm to 1.4 mm. The foldable tire is flexible and can be folded into a compact package for easy transportation and storage

### BACKGROUND OF THE INVENTION

1. Field of the Invention

The present invention relates to a tire structure, and more particularly to a tire that can be folded into a compact package for easy transportation and storage.

2. Description of the Prior Arts

Referring to FIG. 1, a conventional tire 11 generally includes a pair of axially spaced apart beads 12 inserted with a plurality of annular steel wires or filaments 13, when the tire 11 is inflated, the beads 12 will press firmly against the inner edge of a wheel.

The steel wires 13 should be reinforced in order to make the beads 12 of the tire 11 annular shaped, enabling the tire 11 to withstand pressure and to press firmly against the inner edge of the wheel 14. That's why the conventional tire 11 must be inserted with the steel wires 13 that are gathered together and located in the center of the beads 12.

The reinforced steel wires 13 makes the tire 11 annular-shaped but also makes it more resistant to deformation, so that the tires 11 only can be stacked on top of one another or side by side, and this stacking manner takes up too much spaces, and is inconvenient for transportation.

The present invention has arisen to mitigate and/or obviate the afore-described disadvantages.

### SUMMARY OF THE INVENTION

The primary objective of the present invention is to provide a foldable tire that can be folded into a compact package for easy transportation and storage.

A foldable tire comprises a pair of beads interiorly inserted with a plurality of annular members; each of the annular members is made of a plurality of flexible steel filaments twisted together, and the diameter of the respective flexible steel filaments ranging from 0.5 mm to 1.4 mm. The foldable tire is flexible and can be folded into a compact package for easy transportation and storage

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a cross sectional view of showing a conventional tire structure;

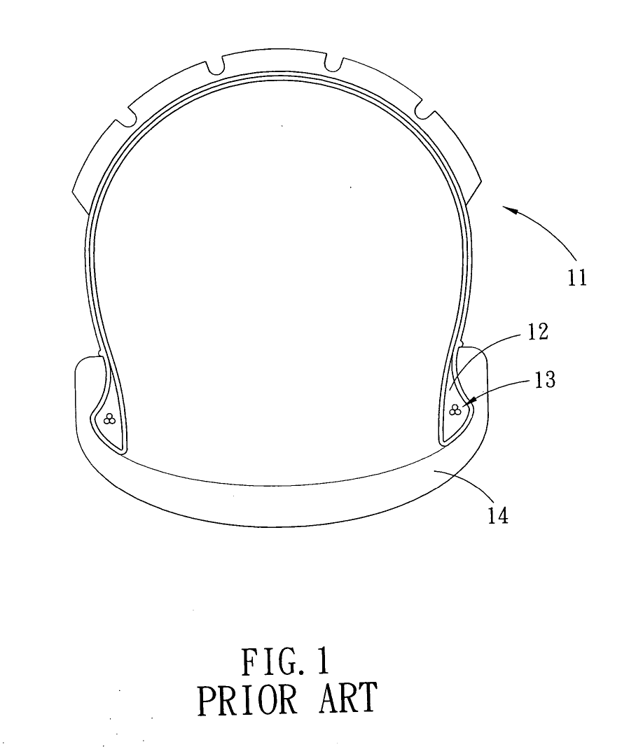

FIG. 2 is a cross sectional view of showing a tire in accordance with a first embodiment of the present invention;

FIG. 3 is an enlarged view of showing an annular member in accordance with a first embodiment of the present invention;

FIG. 4 is an enlarged cross sectional view of a part of the bead of the tire in accordance with a second embodiment of the present invention;

FIG. 5 is an enlarged cross sectional view of a part of the bead of the tire in accordance with a third embodiment of the present invention;

FIG. 6 is an enlarged cross sectional view of a part of the bead of the tire in accordance with a fourth embodiment of the present invention;

FIG. 7 is an enlarged cross sectional view of a part of the bead of the tire in accordance with a second embodiment of the present invention;

FIG. 8 is an enlarged view of showing an annular member wound with a reinforcing member in accordance with another embodiment of the present invention;

FIG. 9 is a perspective view of an annular member in accordance with the present invention.

### DETAILED DESCRIPTION OF THE PREFERRED EMBODIMENTS

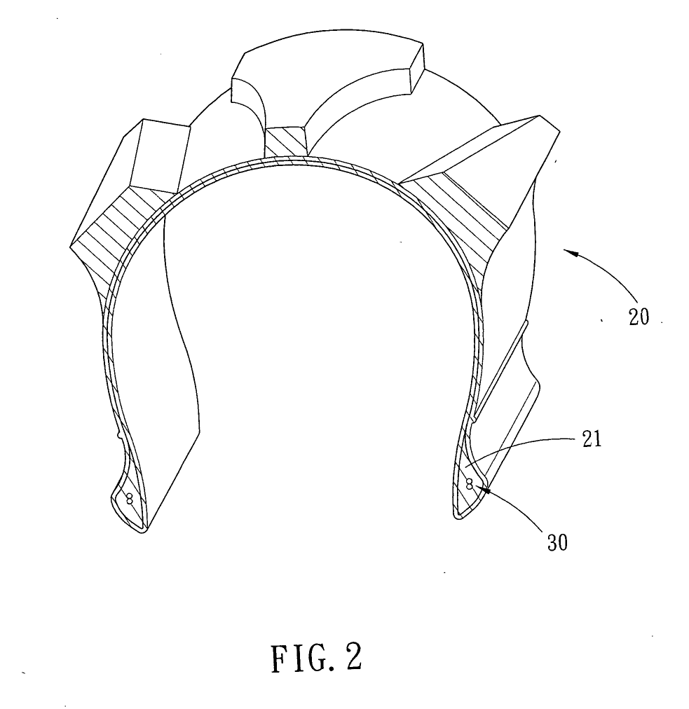

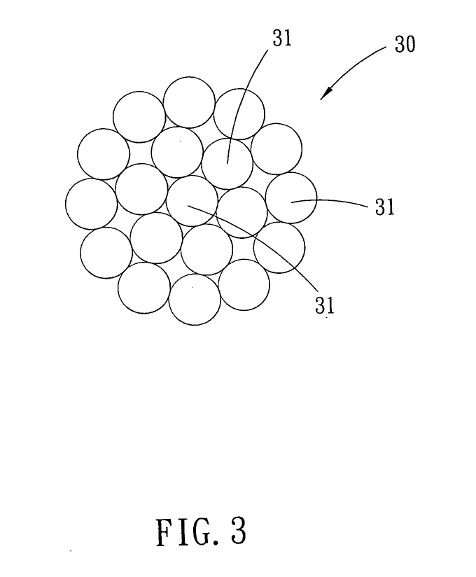

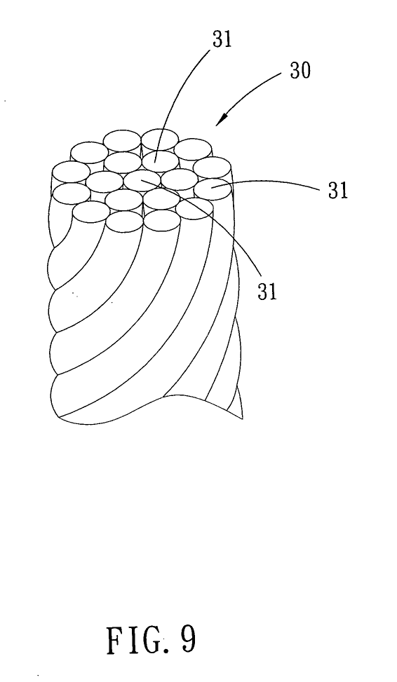

Referring to FIGS. 2, 3 and 9, a foldable tire 20 in accordance with the present invention is shown and comprises a pair of beads 21 interiorly inserted with a plurality of annular members 30.

Each of the annular members. 30 is made of a plurality of flexible steel filaments 31 twisted together, the flexible steel filaments 31 have a diameter ranging from 0.5 mm to 1.4 mm, preferably 1.0-1.2 mm, in this embodiment, it is made of 19 flexible spiral steel filaments.

The annular members 30 made of flexible steel filaments 31 also can make the beads 21 of the tire 20 annular shaped, and enable the beads press firmly against the inner edge of the wheel (not shown) when the tire is inflated. In addition to this, the flexible steel filaments 31 make the annular members 30 pretty flexible and tough, so that the tire 20 can be folded into a compact package for easy transportation and storage, thus substantially saving the transportation cost.

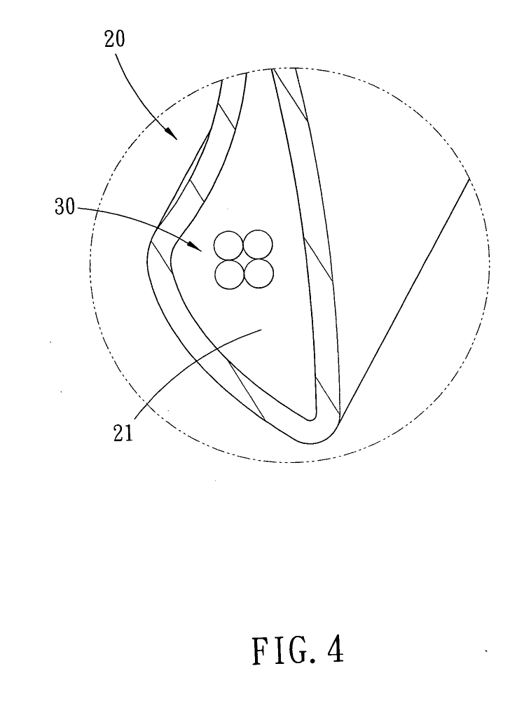

Referring to FIG. 4, which shows two annular members 30 wound two times around the beads 21, so that the annular members 30 are arranged squarely in cross section.

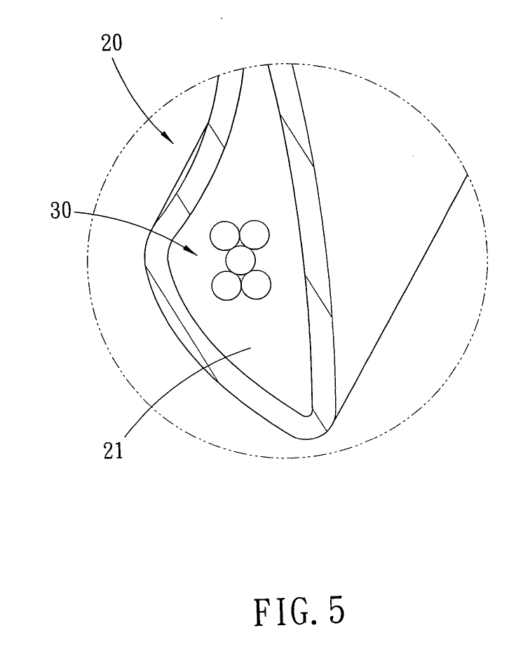

FIG. 5 shows that five annular members 30 wound one time around the beads 21.

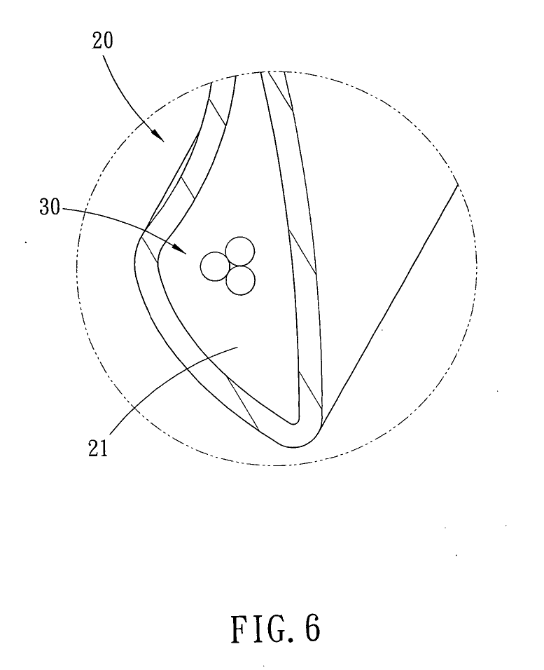

FIG. 6 shows that three annular members 30 are arranged in a triangle and then wound one time around the beads 21.

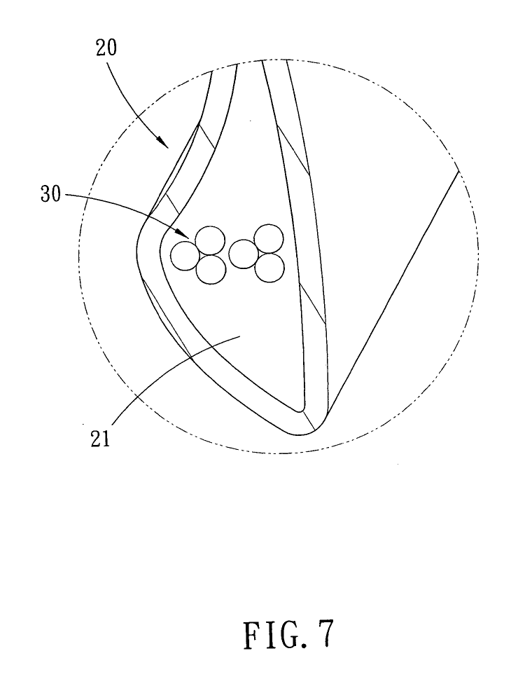

FIG. 7 shows that three annular members 30 are arranged in a triangle and then wound two times around the beads 21.

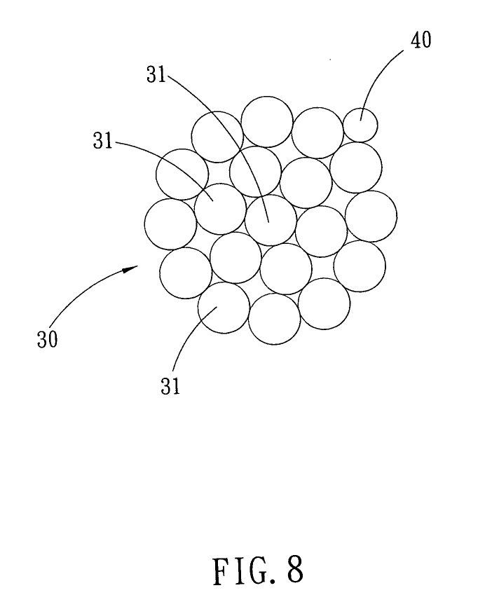

Referring to FIG. 8, a reinforcing member 40 winds around the outmost surface of each of the annular members 30 in order to improve the joint strength therein. The reinforcing member 40 ranges 0.2-1.0 mm in diameter and can be cotton yams or flexible steel filaments.

It is to be noted that there can be one or more annular members 30, in the embodiment, each of the annular members 30 is made of 19 flexible steel filaments 31, and the number of the flexible steel filaments 31 preferably ranges from 7 to 19.

While we have shown and described various embodiments in accordance with the present invention, it should be clear to those skilled in the art that further embodiments may be made without departing from the scope of the present invention.

What is claimed is:

1. A foldable tire comprising a pair of beads interiorly inserted with a plurality of annular members, each of the annular members made of a plurality of flexible steel filaments twisted together, and the flexible steel filaments have a diameter ranging from 0.5 mm to 1.4 mm.

2. The foldable tire as claimed in claim 1, wherein the annular members wind one time around the beads of the tire.

3. The foldable tire as claimed in claim 1, wherein the annular members wind more than one time around the beads of the tire.

4. The foldable tire as claimed in claim 1, wherein the flexible steel filaments are preferably 1.0-1.2 mm in diameter.

5. The foldable tire as claimed in claim 1, wherein each of the annular members is made of 7-19 flexible spiral steel filaments.

6. The foldable tire as claimed in claim 1, wherein each of the beads of the tire is interiorly inserted with two annular members that wind two times around the beads and are arranged squarely in cross section.

7. The foldable tire as claimed in claim 1, wherein each of the beads of the tire is interiorly inserted with five annular members that wind one time around the beads.

8. The foldable tire as claimed in claim 1, wherein each of the beads of the tire is interiorly inserted with three annular members that are arranged in a triangle and then wind one time around the beads.

9. The foldable tire as claimed in claim 1, wherein a reinforcing member winds around an outmost surface of the respective annular members in order to improve joint strength therein.

10. The foldable tire as claimed in claim 1, wherein the reinforcing member is a cotton yarn.

11. The foldable tire as claimed in claim 9, wherein the reinforcing member is a cotton yarn.

12. The foldable tire as claimed in claim 1, wherein the reinforcing member is a flexible steel filament.

13. The foldable tire as claimed in claim 9, wherein the reinforcing member is a flexible steel filament.

14. The foldable tire as claimed in claim 1, wherein the reinforcing member is 0.2-1.0 mm in diameter.

15. The foldable tire as claimed in claim 9, wherein the reinforcing member is 0.2-1.0 mm in diameter.
